(19) United States
(12) Patent Application Publication
(10) Pub. No.: US 2010/0133915 A1
(43) Pub. Date: Jun. 3, 2010

(54) THYRISTOR CONTROLLIED SERIES CAPACITOR ADAPTED TO DAMP SUB SYNCHRONOUS RESONANCES

(75) Inventors: Gunnar Asplund, Ludvika (SE); Changchun Zhou, Beijing (CN); Quianjin Liu, Beijing (CN)

Correspondence Address: VENABLE LLP, P.O. BOX 34385, WASHINGTON, DC, 20043-9998, US

(73) Assignee: ABB Research LTD, Zurich (CH)

(21) Appl. No.: 12/303,051

(22) PCT Filed: May 30, 2006
(86) PCT No.: PCT/SE2006/050171

§ 371 Date: Jun. 24, 2009

(51) Int. Cl. H02J 3/24

(52) U.S. Cl. 307/102

(57) ABSTRACT

An apparatus for controlling a thyristor controlled series capacitor connected to a power transmission line. A thyristor firing control includes a unit for effectuating a desired capacitor voltage zero crossing in dependence of a line current and a capacitor voltage in response to a command signal. A command control provides the command signal to the thyristor firing control. The command control includes a damping control including a damper configured to damp at a least one discrete frequency.

### TECHNICAL FIELD

The present invention concerns control of oscillations in an electric power system. Especially the invention concerns such control by means of a thyristor controlled series connected capacitors (TCSC). The electric power system comprises an electric circuit and a mechanical circuit in cooperation. The mechanical circuit comprises an electric generator and a turbine connected to each other by a shaft. In particular the invention concerns damping of subsynchronous resonances (SSR) in such a power system

### BACKGROUND OF THE INVENTION

Oscillations of active power in power transmission systems may arise in corridors between generating areas and load areas as a result of poor damping of the interconnection, particularly during heavy power transfer. Such oscillations can be excited by a number of reasons such as line faults or a sudden change of generator output or loading.

The control offered by TCSC is an ‘impedance’ type control. The inserted voltage is proportional to the line current. This type of control normally is best suited to applications in power flow corridors, where a well-defined phase angle difference exists between the ends of the transmission line to be compensated and controlled.

An important benefit of TCSC is the ability for quick control of the degree of compensation. This makes the TCSC very useful as a tool for improving the post-contingency behavior of networks. By means of this quality of the TCSC, the degree of compensation of a series capacitor is increased temporarily following upon a network contingency. Dynamic stability is thereby added to the network (voltage and angle) precisely when it is needed. Further active modulation of the boosting of the TCSC (in dependence of some locally measured quantity, e.g. active power) is used to provide damping of electromechanical oscillations (0.1-2 Hz) in the interconnected transmission system. By this feature, the series capacitor may be lower rated for steady-state conditions, thereby keeping costs low.

In a TCSC, the whole capacitor bank, or alternatively a section of the capacitor bank, is provided with a parallel thyristor controlled inductor which circulates current pulses that add in phase with the line current. The capacitive voltage is thereby boosted beyond the level that would be obtained by the line current alone. Each thyristor is triggered once per cycle and has a conduction interval that is shorter than half a cycle of the rated mains frequency. By controlling the additional voltage to be proportional to the line current, the TCSC will be seen by the transmission system as having a virtually increased reactance beyond the physical reactance of the capacitor.

TCSC offers a unique possibility to apply series compensation in networks where the risk for Sub Synchronous Resonance (SSR) is a concern. SSR may arise when complementary series resonance frequency of a compensated line coincides with a poorly damped torsional vibration frequency of the turbo-generator shaft. The interaction that results may exhibit very low or even negative damping. It may cause a torsional oscillation with very high amplitude in the turbine-generator shaft system. Such oscillation induces very high mechanical stress in the shaft. The TCSC acts to eliminate this risk for coinciding resonance frequencies by making the series capacitors act inductive in the subsynchronous frequency band. The occurrence of series resonance in the transmission system would thereby be rendered impossible for subsynchronous frequencies altogether. Inserting a TCSC thus may alleviate limitations on the degree of compensation that are caused by concerns for SSR. Thereby the transfer capability of the transmission system increases.

The control system for a TCSC has to take into account a number of requirements that each is influenced by the control system response in certain time ranges:
SSR behavior, influenced by the TCSC response to line current changes within less than 10 ms (frequency range 10 to 50 Hz),
inserted reactance control at the power frequency, influenced by TCSC response to line current amplitude changes during 50-100 ms, and
power system control, e.g. adding damping to electromechanical power swings, influenced by the TCSC response during several cycles i.e. 100-5000 ms (frequency range 0.1 to 2 Hz).

A natural approach would be to implement the control system as a layered control structure where each layer acts with a certain time horizon and where the layer with the shortest ‘memory’ is located closest to the TCSC. A major advantage with this approach is that it becomes possible to treat the different control objectives separately.

From U.S. Pat. No. 5,801,459 a method and a control equipment for a series capacitor connected into an electric power line is previously known. The object of the control equipment is to provide simple and, in principle, lossless equipment which efficiently damps subsynchronous resonances independently of variations in the operating conditions. In the known equipment a thyristor valve is controlled in such a way that the apparent impedance of the series capacitor equipment within the whole range in which the SSR oscillation may occur becomes inductive instead of capacitive.

The known equipment controls the semiconductor valve such that the capacitor voltage zero crossings remain equidistant during processes when the line current contains subsynchronous components. The series capacitor equipment will systematically exhibit an inductive character within the whole frequency range which is of interest for SSR. This inductive character is achieved independently of the control state of the capacitor, independently of the characteristics of the power line or the power network, and independently of the magnitude of the fundamental component of the current in the power line.

The capacitor means and the parallel path containing the thyristor switched reactor forms a TCSC. The control equipment comprises a firing circuit which upon a command signal sends a firing pulse to the thyristor valve. Based on the measured instantaneous values of capacitor voltage and line current, this circuit compensates the varying delay between the firing of the thyristor valve and the zero crossing of the capacitor voltage which arises because of the finite reversal time of the thyristor-inductor-capacitor circuit. The compensating firing circuit delivers firing pulses to the thyristor valve. The control equipment also comprises a boost controller which by sending command orders to the firing circuit effectuates the boost level of desire.

Although the control equipment according to U.S. Pat. No. 5,801,459 effectively reduces the negative damping at a wide frequency range where the SSR is likely to appear it still is dependent on the presence of a positive mechanical damping in the system. In a real system mechanical damping always exists and it is positive although the damping coefficient is very small. The main obstacle is that it is very difficult to determine a definite value of mechanical damping. Some values may be obtained by measurements on the generator once it has been installed. It is not possible, however, to get guaranteed calculated values during the design stage. Therefore the potential risk of SSR must be evaluated based on assumed mechanical damping values obtained from earlier experience.

### SUMMARY OF THE INVENTION

A primary object of the present invention is to seek ways to improve the control of a power network to mitigate the occurrence of subsynchronous resonances (SSR) that could harm the mechanic or the electric equipment.

This object is achieved according to the invention by a control apparatus characterized by the features in the independent claim 1 or by a method characterized by the steps in the independent claim 8. Preferred embodiments are described in the dependent claims.

According to the invention a TCSC is controlled to produce a positive damping of the power modulation in a narrow band around a discrete frequency. The discrete frequency is selected in advance and represents a natural frequency of the torsional oscillation of the mechanical system. Thus when such discrete modulation frequency appears on the transmission line the TCSC is controlled to increase the damping in a narrow band around the discrete frequency. Hence by safeguarding a positive damping from the electric network the power system is not dependent on a positive damping of the mechanical system.

The discrete frequency of selection is a natural frequency resulting from a calculation of oscillation behaviour of the system. The discrete frequency may also be chosen from sensed natural frequencies on the transmission line. Hence the damping control may be defined from an apparent situation and does not have to be defined prior the erection of the power plant. In an embodiment of the invention damping is arranged for a plurality of discrete frequencies.

In an embodiment of the invention the appearance of a discrete frequency is sensed by a bandpass filter acting on the measured active power in the transmission line. On sensing a signal indicating the presence of such frequency the signal is gained and phase shifted and supplied to the firing circuit of the control equipment for the TCSC, thereby performing a positive damping in a small range around the sensed discrete frequency.

In a further embodiment of the invention the control equipment for the TCSC comprises a damping controller and a firing circuit. The damping controller receives the information of the appearance of a discrete frequency and provides a control signal to the firing circuit which provides damping in a narrow band around the discrete frequency. In an embodiment the damping control receives feedback information from local measurements on the power line to control the output signal to the firing circuit.

In yet a further embodiment of the invention the control equipment comprises a boost controller and a phase-locked loop (PLL). In this embodiment the signal from the boost control and the signal from the damping control is combined and supplied to the firing circuit. In yet a further embodiment the damping signal may be combined with the signal from the PLL. As the electrical damping is brought close to the zero line by the use of TCSC with the firing control a fairly small additional feedback control is needed to make the electrical damping definite positive thereby eliminating the dependence on the mechanical damping.

An ideal damping system takes the speed variation of the generator as input and controls an actuator that produces a proportional breaking torque variation. However, normally the generator is positioned remote from the series capacitor installation and it is difficult and expensive to provide secure signal transmission with sufficient small delay. Utilizing local signals that are as tightly related to the generator speed variation as possible is thus advantageous.

The topology of the power system determines how difficult or easy it is to implement such an additional feedback damping. The radial system, which is by its topology most prone to experience SSR problems, also is the one in which a reliable additional damping can most easily be implemented.

The total power flow in a radial transmission system reflects the phase angle of the generator relative the remaining power system. The total power is high whenever the generator phase is phase advanced relative the rest of the network and it is low when the phase is retarded. Therefore variations in the generator phase are extracted from local measurements of the total active power flow in the corridor at the series capacitor installation. Other quantities, like local frequency, are also used to derive information about the actual generator phase or speed deviations.

From measured quantities adequate control signals are created, which is added to the TCSC control in such a way that a positive contribution to the electrical damping results. Often the critical mechanical frequencies in the shaft system in the generating plant are known and then the added signal is shaped to provide damping at such selected known frequencies.

A damping system according to the invention contains a TCSC control system with thyristor firing control according to the algorithm for exactly determine the exact moment for firing the thyristors and an additional feedback damping system that takes a locally measured signal as input and provides an output signal, which is used as an input signal to the firing control. Thus the damping signal is added to the boost control output signal or the PLL signal.

In a first aspect of the invention the object is achieved by a control apparatus of a thyristor controlled series capacitor means connected to a power transmission line, the control apparatus comprising a thyristor firing control responsive to a command signal for effectuating firing pulses to the thyristor valve in the dependence of the line current and the capacitor voltage to cause valve switching at desired instants, a command control responsive to an outer phase reference signal for effectuating command pulses to the thyristor firing control, wherein the command control comprises a damping control responsive to the presence of a discrete frequency on the transmission line for effectuating command signals to the thyristor firing control to achieve positive damping of the network at a frequency range around the discrete frequency. In an embodiment of the invention the command control comprises a boost control and a phase-locked loop.

In a second aspect of the invention the object is achieved by a method for providing a positive damping of a discrete frequency oscillation present on a power transmission line, the power transmission line comprising a thyristor controlled series capacitor means with a thyristor firing control, the method comprising, providing a signal representing the oscillation present on a power transmission line, filtering the signal, sensing the presence of the discrete frequency, phase shifting the signal, and sending a command signal to the thyristor firing control for effectuating the damping effect.

### BRIEF DESCRIPTION OF THE DRAWINGS

Features and advantages of the present invention will become more apparent to a person skilled in the art from the following detailed description in conjunction with the appended drawings in which:

FIG. 1 is a principal layout of a mechanic system connected to an electric system,

FIG. 2 is principal circuit of a control apparatus according the invention,

FIG. 3 is a diagram showing the effect of the control apparatus,

FIG. 4 is one embodiment of the control apparatus according to the invention, and

FIG. 5 is a further embodiment of the control apparatus.

### DESCRIPTION OF PREFERRED EMBODIMENTS

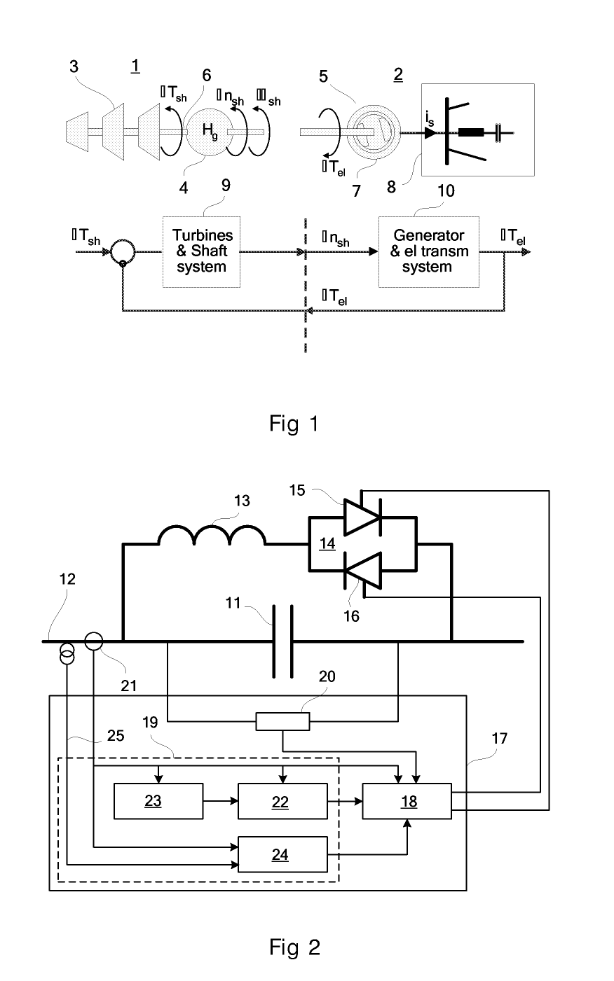

FIG. 1 illustrates mechanical system 1 connected to an electrical system 2. The mechanical system comprises a turbine 3 and the rotor part 4 of a generator 5 connected to the turbine with a shaft 6. The electrical system comprises the stator part 7 of the generator and the network 8 connected to the generator. The mechanical shaft system is characterized by the small-signal transfer function from applied torque deviation to shaft speed deviation (“Turbines & Shaft system”). The electrical system can be represented by the block “Generator & el transm system”, which has the transfer function from applied speed deviation to electrical torque deviation. These two transfer functions are connected in cascade. The stability of the feed-back system is determined by the properties in the electrical system.

When the shaft speed of the generator is modulated with frequency f_{mech} its phase relative the rest of the electrical network will vary with the same frequency. The active power exchange with the network then fluctuates with frequency f_{mech}. The phase modulation introduces sub- and super-synchronous currents in the transmission system. These currents have the frequencies f_{gen}−f_{mech} and f_{gen}+f_{mech} respectively. The subsynchronous frequency f_{gen}−f_{mech} is close to f_{gen} when f_{mech} is small and then the network impedance is inductive as the degree of compensation is less than 100%. Then the electrical torque variation counteracts the speed modulation. However, when the modulation frequency f_{mech} increases the subsynchronous frequency f_{gen}−f_{mech} decreases. If the line is series compensated with a passive capacitor bank the network impedance becomes capacitive at a certain frequency and then the electromechanical torque created by the subsynchronous current instead amplifies the shaft speed modulation, making the oscillation amplitude increase.

A thyristor controlled series capacitor (TCSC) means according to the invention is described in FIG. 2. A capacitor means 11 is series connected on an electric power transmission line 12. A second path in parallel with the capacitor means comprises an inductor means 13 and a thyristor switch 14. The thyristor switch comprises a first 15 and second 16 thyristor means arranged in antiparallel paths. Further the TCSC comprises a control apparatus 17 arranged to effectuate the control of the thyristor switch in response to a desired operation.

The control apparatus comprises a firing control 18 and a command control 19. The control apparatus further comprises a voltage sensing means 20 arranged to measure the capacitor voltage and a current sensing means 21. A further voltage sensing means 25 is arranged to measure the line voltage. The voltage sensing means may comprise by way of example a voltage transformer or a voltage divider with optical signal transmission. The firing control comprises computer means to calculate in response to a command signal and the capacitor voltage the exact moment to fire the thyristors to effectuate a zero crossing of the capacitor voltage at an instant desired by the command.

The command control comprises a boost control 22 and a phase-locked loop (PLL) means 23 for providing equidistant command pulses to the command control. The command control further comprises a damping control 24. The damping control calculates a damping signal in response to the line current and line voltage. The damping control comprises filtering means to detect a discrete frequency from local measurements. Hence the damping control operates on signal comprising a combination of the line current and voltage signals on the transmission line (e.g. active power). Further the damping means comprises computer means for effectuating a command signal to the firing control to the effect of producing a positive damping of the electric network in a narrow band around the discrete frequency. The discrete frequency is a chosen frequency from one of the natural frequencies of the mechanical system. By providing a positive damping at frequency bands around such a discrete frequency to fade out an exited natural frequency is ensured.

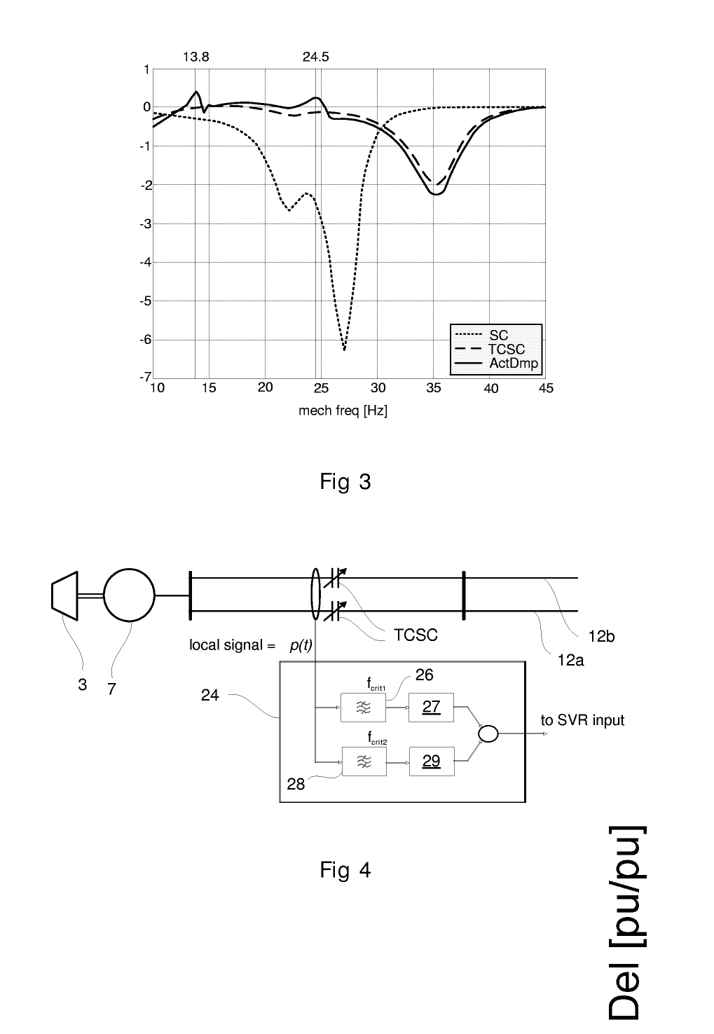

In general the damping conditions for the electrical subsystem can be characterized by a curve that shows the relation between the component in phase with the speed modulation of the electrical torque and the speed modulation itself. In FIG. 3 depicts such curves for a specific generator in a radial transmission network. The dotted curve shows negative electrical damping in a wide frequency range from 15 Hz to about 30 Hz resulting from electrical damping for series compensation using fixed capacitor banks only. These characteristics make it impossible to utilize series compensation with the given degree of compensation if the generator shaft system has any significant swing mode within this range.

The reactance of the inductance in the TCSC is much smaller than the reactance of the capacitor bank; typically the ratio ranges from 5 to 15 times. The TCSC is phase-angle controlled and the thyristor branch is passed by short current pulses during each half-cycle of the network frequency. The TCSC has a distinctly different response to subsynchronous line currents than the fixed series capacitor. At low frequency the apparent impedance of the TCSC approaches zero whereas the reactance for a fixed series capacitor approaches negative infinity. Experiments has shown that the apparent impedance of the thyristor controlled part of the TCSC can be kept inductive in the whole subsynchronous resonance frequency range from about 10 Hz to approximately 30-45 Hz (50 Hz system) or 40-55 Hz (60 Hz). When a portion of the installed fixed series capacitors is being replaced by a TCSC the electrical damping curve is modified as is shown by the broken line in FIG. 3.

FIG. 3 also depicts the electrical damping curve, black line, in a certain case where additional damping according to the invention has been added at the mechanical frequencies 13.8 Hz and 24.5 Hz. In the example the bandwidth of the active damping at the lower frequency has been selected narrower than at the higher frequency.

FIG. 4 shows a radial system having several parallel lines in a bulk power transmission corridor. A turbine 3 and a generator 7 are connected to a first transmission line 12a and a second transmission line 12b. Both transmission lines comprise a TCSC according to the invention. A damping control 24 senses a local signal p(t) from the first and second transmission line. The signal is filtered by a first bandpass filter 26 and a second bandpass filter 28. These filters are tuned to detect a discrete frequency of desire. On appearance of a signal from the first filter the signal a first gain controller 27 is phase shifting the signal. On appearance of a signal from the second filter a second gain controller 29 is phase shifting the signal. Both of these signals are added before sending to the firing control.

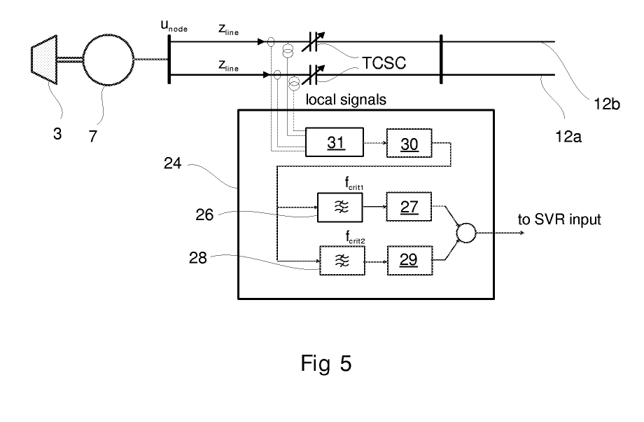

Another alternative uses the measured voltage and current at the TCSC site. The impedance of the line from the site to the node close to the generator is known and therefore it is possible to estimate the voltage vector at that node. The speed (frequency) of the voltage vector reflects the mechanical speed of the generator. Thus it can be used as an input signal for the additional damping system. FIG. 5 illustrates this system.

In FIG. 5 a second embodiment of the damping control is shown. The second embodiment has the same principal structure as the embodiment in FIG. 4, and uses the same indication numbers. In this embodiment however the signal sensed by the filters has been evaluated from both current measurement and voltage measurement on both of the transmission lines. An estimating means 31 is delivering a signal to a frequency measurement means 30 on a response to the information gained from the transmission lines. The first 26 and second 28 filters are arranged to detect the presence of a first and second discrete frequency from the signal supplied from the measurement means 30.

Although favorable the scope of the invention must not be limited by the embodiments presented but contain also embodiments obvious to a person skilled in the art. For instance the filter means may comprise a plurality of filters, each designed to detect the presence of at least one of a plurality of desired discrete frequencies.

1. A control apparatus for controlling a thyristor controlled series capacitor connected to a power transmission line, the control apparatus comprising:
a thyristor firing control comprising means for effectuating a desired capacitor voltage zero crossing in dependence of a line current and the capacitor voltage in response to a command signal, and
a command control for providing the command signal to the thyristor firing control, wherein the command control comprises a damping control comprising a frequency damper configured to damp at a least one discrete frequency.

2. The apparatus according to claim 1, wherein the command control further comprises a boost control and a phase-locked loop.

3. The apparatus according to claim 2, wherein a bandwidth of the firing control is higher than a bandwidth of the boost control and the phase-locked loop.

4. The apparatus according to claim 2, wherein in absence of a discrete frequency the command control effectuates an equidistant capacitor voltage zero crossing.

5. The apparatus according to claim 1, wherein the damping control comprises a filter.

6. The apparatus according to claim 1, wherein the damping control comprises an amplifier and a phase shifter.

7. The apparatus according to claim 1, wherein the damping control comprises a frequency measurer and an estimator.

8. A method for providing a positive damping of a discrete frequency oscillation present on a power transmission line, the power transmission line comprising a thyristor controlled series capacitor comprising a thyristor firing control, the method comprising:
providing a signal representing the oscillation present on a power transmission line,
filtering the signal,
sensing a presence of the discrete frequency,
phase shifting the signal, and
sending a command signal to the thyristor firing control for effectuating the damping.

9. The method according to claim 8, wherein the signal is a frequency of an estimated voltage in a node close to a generator, and the estimated voltage is reconstructed from a measured line current and voltage at the position of the thyristor controlled series capacitor using a known impedance of a line between a position of the thyristor controlled series capacitors and the generator.

10. The method according to claim 8, wherein the command signal is sent from a boost control and is added to a damping signal.

11. The method according to claim 10, wherein the command signal from the boost control is responsive to a phase-locked loop.

12. A computer program product, comprising:
a computer readable medium; and
computer program instructions recorded on the computer readable medium and executable by a processor to carryout a method comprising providing a signal representing an oscillation present on a power transmission line, filtering the signal, sensing a presence of a discrete frequency, phase shifting the signal, and sending a command signal to a thyristor firing control for effectuating a damping.

13. The computer program product according to claim 12, wherein the computer program instructions are further for providing the computer program instructions at least in part over a network.

14. The computer program product according to claim 12, wherein the computer program are further for providing the computer program instructions at least in part over the internet.
